(19) United States
(12) Patent Application Publication
(10) Pub. No.: US 2025/0074814 A1
(43) Pub. Date: Mar. 6, 2025

(54) REINFORCED GLASS-CERAMIC ARTICLE

(71) Applicant: EUROKERA S.N.C., CHATEAU-THIERRY (FR)

(72) Inventors: Thibault GUEDON, PARIS (FR); Micheline PLICHARD, FERE EN TARDENOIS (FR); Xavier BRAJER, CORMEILLES EN PARISIS (FR); Nicolas ROUX, CHATEAU-THIERRY (FR)

(21) Appl. No.: 18/251,195

(22) PCT Filed: Oct. 28, 2021
(86) PCT No.: PCT/FR2021/051902

§ 371 Date: Apr. 28, 2023

(30) Foreign Application Priority Data
Oct. 30, 2020 (FR) 2011128

(51) Int. Cl. C03C 10/00; C03C 17/00; C03C 17/32; C03C 23/00; C03C 25/36; C03C 27/06

(52) U.S. Cl. CPC C03C 10/0027; C03C 17/007; C03C 17/32; C03C 23/007; C03C 25/36; C03C 27/06; C03C 2217/445; C03C 2217/465; C03C 2217/475; C03C 2218/32

(57) ABSTRACT

A glass-ceramic article includes at least one substrate, such as a plate, made of glass-ceramic material, the substrate being coated on its lower face, in at least one zone, with at least one fibrous structure including a resin.

### TECHNICAL FIELD OF THE INVENTION

The present invention relates to the field of glass-ceramics. More precisely, it concerns an article, or product, made of glass-ceramic, in particular a glass-ceramic plate intended to be used as a furniture surface and/or a cooking surface.

By glass-ceramic article, we mean an article based on a substrate (such as a plate) made of a non-porous glass-ceramic material, said substrate being able to be equipped with accessories or additional elements, decorative or functional, required for its end purpose, the article being able to designate the substrate alone as well as the one equipped with additional equipment (for example a cooking plate equipped with its control panel, its heating elements, etc).

### TECHNOLOGICAL BACKGROUND OF THE INVENTION

A glass-ceramic is originally a glass, called precursor glass, or mother glass or green glass, the specific chemical composition of which allows controlled crystallization to be induced by suitable heat treatments, called ceramization. This specific, partly crystallized structure gives the glass-ceramic unique properties.

There are currently different types of glass-ceramics, each variant being the result of major studies and numerous tests, given that it is very difficult to make changes on these plates and/or to their method of obtaining without risking an unfavorable effect on the desired properties.

The glass-ceramic plates must also have sufficient mechanical strength as required in their field of use. In particular, to be used as a cooking plate in the field of household appliances or as a furniture surface, a glass-ceramic plate must have good resistance to pressure, to impacts (support and falling utensils, etc.), etc.

Traditionally, glass-ceramic plates are used as cooking plates, or they can also be combined with heating elements in other applications, for example to form fireplace inserts. Recently, their use has been extended to other areas of everyday life: glass-ceramic plates can be used as furniture surfaces, in particular to form worktops, central islands, consoles, etc. The surface area they occupy in these new applications is larger than in the past.

Document FR 2868065 A1, in the name of the Applicant, describes glass-ceramic plates whose mechanical strength is reinforced by the addition of a paint applied by screen printing and polymerized at 250° C. in air. This layer is deposited over the entire lower face.

The present invention aims to obtain greater mechanical strength.

Currently, in order to increase the impact strength of the glass-ceramic plates, it is also possible to:
either increase their thickness,
or to carry out severe control of the manufacturing method: limit friction/scratches at the lower face, or enhanced quality control of defects at the outlet of the furnace.

The inventors have demonstrated that it is possible to improve the impact strength of the glass-ceramic plates by applying to their lower surface a fibrous structure comprising a resin, in particular a structure such as those generally called “prepreg”.

### SUMMARY OF THE INVENTION

The present invention relates to a glass-ceramic article, comprising at least one substrate, such as a glass-ceramic plate, said substrate being coated, on its lower face, in at least one zone, with a fibrous structure comprising fibers and a resin matrix, in particular a polymeric resin matrix.

In particular, the article according to the invention is a cooking device further comprising one or more heating elements.

In particular, said fibrous structure comprises fibers chosen from glass fibers, carbon fibers, aramid fibers, quartz fibers, kevlar fibers and mixtures thereof. Preferably, the fibers are glass fibers or carbon fibers, and even more preferably glass fibers.

Advantageously, said fibrous structure has a fiber density of between 50 and 1000 g/m², preferably between 100 and 800 g/m² and more preferably between 150 and 600 g/m².

In particular, said resin is chosen from thermosetting resins, preferably from epoxy, phenolic or polyimide resins.

The fibrous structure may comprise one or more layers of a woven, unidirectional or multiaxial structure, preferably a woven structure.

In particular, said structure is deposited on at least 40% of the surface of the substrate, preferably over at least 50% and even more preferably at least 60% of the surface of the substrate. Gaps are provided in the fibrous structure, at the location of the heating zones, optionally of the control strip, and the edges of the substrate.

In particular, said fibrous structure has an expansion coefficient greater than the coefficient of expansion of the glass-ceramic plate.

According to particular embodiments, the substrate also comprises, on certain parts of its surface, an enamel coating, advantageously deposited on the upper face of the substrate.

Another object of the present invention is a method for manufacturing a glass-ceramic article comprising at least one substrate, such as a plate, made of glass-ceramic material, on which a fibrous structure comprising fibers and a resin matrix is applied, then said substrate, thus coated, is subjected to a heat treatment under pressure (in an autoclave) or under vacuum.

The heat treatment is generally carried out at a temperature of between 10° and 200° C., preferably between 12° and 150° C., at a pressure of between 100 and 400 mbar, preferably between 150 and 350 mbar and for a period of time comprised between 30 min and 3 hours, preferably between 40 min and 2 hours, and even more preferably between 50 min and 1 hour 30 min.

The glass-ceramic article according to the invention is in particular a plate, or a device or apparatus, for cooking or any item of furniture integrating (or comprising, or formed of) at least one substrate made of glass-ceramic material (the substrate is most commonly in the form of a plate, integrated or mounted in the unit and/or combined with other elements in order to form the unit), said substrate possibly, where appropriate, having zones with a display character (in combination for example with light-emitting sources) or decorated zones or be combined with heating elements. In its most common application, the article according to the invention is intended to serve as a cooking plate, this plate generally being intended to be integrated into a cooktop or cooker also comprising heating elements, for example radiant or halogen heaters or induction heating elements.

When the article according to the invention is a cooking hob comprising heating zones and a control strip, before applying the fibrous structure, the latter is precut to the size of the substrate and gaps are cut into the structure at the heating zones and optionally at the control panel.

The thickness of the glass-ceramic substrate is generally at least 2 mm, in particular at least 2.5 mm, and is advantageously less than 15 mm, in particular is on the order of 3 to 15 mm, in particular on the order of 3 to 8 mm or on the order of 3 to 6 mm. The substrate is preferably a flat or quasi-planar plate (in particular with an arrow of less than 0.1% of the diagonal of the plate, and preferably on the order of zero).

The substrate can be based on any glass-ceramic, this substrate advantageously having a coefficient of thermal expansion (CTE) of zero or almost zero, in particular lower (in absolute value) than 30.10⁻⁷ K⁻¹ between 20 and 700° C., in particular lower than 15. 10⁻⁷K⁻¹, or even lower than 5. 10⁻⁷ K⁻¹ between 20 and 700° C.

The invention is particularly advantageous for substrates of dark appearance, these substrates being slightly transmissive and not very scattering, and being in particular based on any glass-ceramic having, intrinsically, a light transmission T_{L} less than 40%, in particular less than 5%, in particular from 0.2 to 2% for glass-ceramics up to 6 mm in thickness, and an optical transmission (determined in a known manner by making the ratio between the transmitted intensity and the incident intensity at a given wavelength) between 0.5 and 3% for a wavelength of 625 nm included in the visible range.

The term “intrinsic” is understood to mean that the substrate possesses such transmission properties itself, without the presence of any coating. The optical measurements are made according to the EN 410 standard. In particular, luminous transmission T_{L} is measured according to standard EN 410 using illuminant D65 and is the total transmission (especially integrated over the visible domain and weighted by the spectral sensitivity curve of the human eye) taking into account both direct transmission and possible diffuse transmission, the measurement being carried out, for example, using a spectrophotometer equipped with an integrating sphere (in particular the spectrophotometer sold by the company Perkin Elmer as the product Lambda 950)

According to one embodiment, the substrate is black or brown in appearance, making it possible, in combination with light sources placed underneath, to display luminous zones or decorations, while masking any underlying elements. It can be based on a black glass-ceramic comprising crystals with a β-quartz structure in a residual vitreous phase, the absolute value of its coefficient of expansion being advantageously less than or equal to 15. 10⁻⁷K⁻¹ or even 5. 10⁻⁷ K⁻¹, such as the glass-ceramic of the plates marketed under the name Kerablack+ by the company Eurokera. It may in particular be a glass-ceramic with a composition as described in patent application EP0437228 or U.S. Pat. No. 5,070,045 or FR2657079, or a tin-refined glass-ceramic having a content of arsenic oxides preferentially less than 0.1%, as described for example in patent application WO 2012/156444, or else a glass-ceramic refined to the sulfide(s) as described in patent application WO2008053110, etc.

According to one embodiment, the substrate may have an acid-frosted upper surface.

According to another embodiment, the substrate is opaque and/or not very transmitting, while being scattering and sufficiently clear (the clarity being given by the luminosity L*), the glass material being in particular colored or tinted in its bulk (this coloring including white and all the colors with a luminosity L* of greater than 10, the darker colors, such as black or dark brown, being excluded), as specified below.

The glass-ceramic used can in particular have a composition as described in the patent applications published under the following numbers: EP1300372, U.S. Pat. No. 6,706,653, WO9906334, WO2007113242, EP1840093, US2007213192, U.S. Pat. No. 7,476,633, JP2009531261, WO2012156444, WO2012001300, DE202012011811, this glass-ceramic being in particular a lithium aluminosilicate glass-ceramic and also advantageously comprising colorants.

Use is advantageously made, for example, of a glass-ceramic comprising the following constituents and/or obtained by ceramization starting from a glass with the following composition, within the limits below, expressed as percentages by weight: SiO₂: 52-75%; Al₂O₃: 18-27%; Li₂O: 2.5-5.5%; K₂O: 0-3%; Na₂O: 0-3%; ZnO: 0-4%; MgO: 0-5%; CaO: 0-2.5%; BaO: 0-3.5%; SrO: 0-2%; TiO₂: 0-5.5%; ZrO₂: 0-3%; P₂O₅: 0-8%; B₂O₃: 0-5%, and preferably, within limits below, expressed as percentages by weight: SiO₂: 55 70%; Al₂O₃: 18-24%; Li₂O: 2.5-4.5%; K₂O: 0-2.0%; Na₂O: 0-2.0%; ZnO: 1.5-4%; MgO: 0.20-5%; CaO: 0-1%; BaO: 0-3%; SrO: 0-1.4%; TiO₂: 1.8-5%; ZrO₂: 0-2.5%; P₂O₅: 0-8%; B₂O₃: 0-5%, this composition also comprising, if appropriate, additional colorants.

The substrate according to the invention may, where appropriate, be coated with other coatings or layers with functional effect (anti-overflow layer, opacifying layer, etc.) and/or decorative, in particular localized, such as usual patterns based on enamels (for example on the upper face to form simple patterns or logos) or a layer of opacifying paint on the lower face of the substrate, etc. In particular, the substrate may be coated with at least one layer of enamel and/or paint, in particular of the gloss type, located or not.

The article according to the invention may further comprise, associated or combined with the substrate, one or more light sources and/or one or more heating elements (such as one or more radiant or halogen elements and/or one or more atmospheric gas burners and/or one or more induction heating means), generally placed on the lower face of the substrate. The article according to the invention in particular has good thermal resistance compatible with the use of various types of heating. The product according to the invention is in particular not subjected to thermal degradation at temperatures above 400° C. that can be achieved in particular in applications such as the use as cooking plates.

Where appropriate, the process also includes a cutting operation (generally before ceramization), for example using a water jet, mechanical scoring using a scoring wheel, etc., followed by a shaping operation (grinding, beveling, etc.).

### BRIEF DESCRIPTION OF THE FIGURES

FIG. 1 shows the strength results of examples 1a, 1 b and 1c relative to Ref 1;

FIG. 2 shows the strength results of examples 3a, 3b and 3c relative to Ref 3;

FIG. 3 shows the results of comparative example 4 relative to Ref 4;

### DETAILED DESCRIPTION

### Ball Drop Test:

A test was developed to identify the impact strength of glass-ceramic plates. It consists of placing a sample of glass-ceramic substrate on a wooden frame and dropping a 500 g steel ball bearing at heights of 5 to 195 cm, incremented by steps of 5 cm until the sample breaks.

The results table includes:
the height of the sample that broken at the lowest ball drop height;
the height of the sample that broken at the highest drop height; and
the average height for all of the samples.

Samples that withstood impact at 195 cm are considered to have broken at 195 cm. This gives a slight under-estimation of the average fall height.

### Example 1

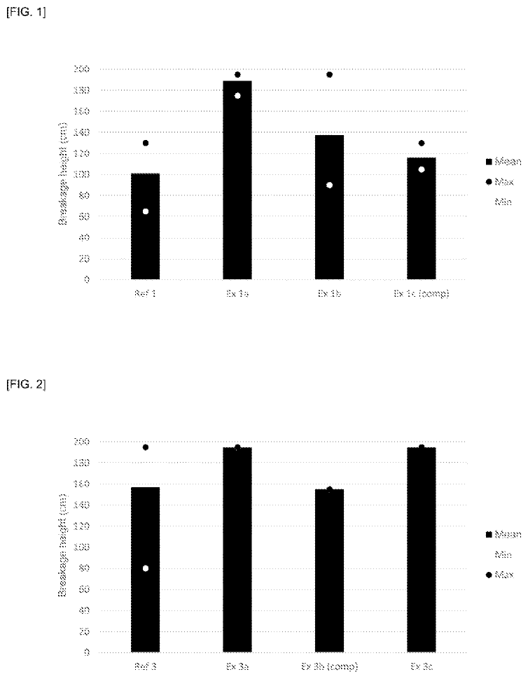

### FIG. 1

Reference 1: 10 white glass-ceramic plates of the Kerawhite® type of 300×300 mm² and 6 mm thick were subjected to the ball drop test.

Example 1a): 5 samples of white glass-ceramic of the Kerawhite® type of 300×300 mm² each 6 mm thick were covered on their lower face with three plies of a TenCat Laminate 7781 pre-impregnated fabric. Each ply comprises glass fibers at a density of 300 g/m², impregnated with an Epoxy resin.

The samples were then subjected to an autoclave treatment.

Example 1b): 8 samples of white glass-ceramic of the Kerawhite® type 300×300 mm² each 6 mm thick were covered on their lower face with one ply of a CBX401 pre-impregnated fabric from the company Sicomin. The fabric comprises glass fibers at a density of 400 g/m², impregnated with an Epoxy resin (IMP503Z).

The samples were then subjected to a heat treatment for 1 hour 30 min at 130° C. at atmospheric pressure.

Example 1C) (comparative): 5 samples of white glass-ceramic of the Kerawhite® type 300×300 mm² and 6 mm thick were covered on their lower face with an epoxy resin of the non-fiber-reinforced Loctite EA9497 type. The resin is polymerized in the open air, without heat treatment.

### Example 2

Reference 2: The same white glass-ceramic plates of the Kerawhite® type, 300×300 mm² and each 6 mm thick, as in example 1, are used. In this example, they are deposited on a flat laminated wood support with a thickness of 28 mm.

Example 2: A sample was covered on its lower face with three plies of a pre-impregnated fabric of the TenCat Laminate 7781 type. Each ply comprises glass fibers impregnated with an Epoxy resin at a density of 300 g/m².

The sample was then subjected to a heat treatment for 1 hour, under vacuum, at 120° C. During the test, the sample is also placed on a laminated wood support with a thickness of 28 mm.

### Example 3

### FIG. 2

Reference 3: Black glass-ceramic plates of 6 mm thick, of the Kerablack+® type are used. In this example, they have dimensions of 900×600 mm².

Example 3a: A sample was covered on its lower face with two plies of a pre-impregnated fabric of the GG204T Sergé type. Each ply comprises carbon fibers at a density of 220 g/m², impregnated with an Epoxy resin.

The sample was then subjected to a one-hour treatment, under vacuum, at 120° C.

Example 3b (comp): A sample was covered on its lower face with two plies of a pre-impregnated fabric of the GG204T Sergé type. Each ply comprises carbon fibers at a density of 220 g/m², impregnated with an Epoxy resin.

The sample was then subjected to a one-hour treatment at 120° C.

Example 3c: Another sample was covered on its lower face with a ply of a fiberglass fabric (300 g/m2) impregnated with an epoxy resin. The sample was then subjected to a one-hour heat treatment at 130° C. and at 250 mbar.

### Example 4

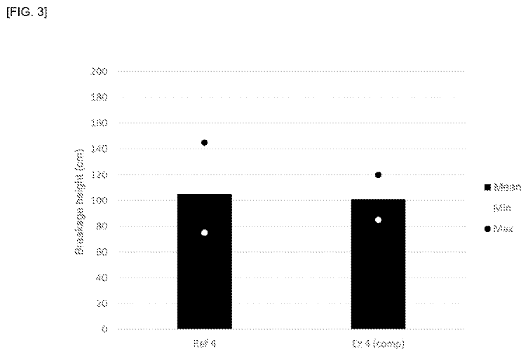

### FIG. 3

Reference 4: Black glass-ceramic plates 6 mm thick, of the same Kerablack+® type as in Example 3, are used. In this example, they have dimensions of 300×300 mm².

Example 4 (comparative): five samples were covered on their lower face with Epoxy glue and then with a glass fiber fabric of the EV200 type (not impregnated beforehand).

The fabric is adhesively bonded manually without heat treatment. The resin is polymerized in the open air.

### Results

FIG. 1 shows the breakage heights (averages, minimum and maximum) of example 1.

FIG. 2 shows the breakage heights (averages, minimum and maximum) of example 3.

FIG. 3 shows the breakage heights (averages, minimum and maximum) of example 4.

The table below shows the breakage height values of each of the exemplary embodiments obtained during the ball drop test. A star “*” indicates that the plate withstood without damage at this ball drop height.

TABLE 1

| | Min | Max | Mean | Fragment |
|---|---|---|---|---|
| | height | height | height | retention |
| Ref 1 | 65 | 130 | 101 | no |
| Ex 1a | 175 | 195* | 189 | yes |
| Ex 1b | 90 | 195* | 138 | yes |
| Ex 1c (comp.) | 105 | 130 | 116 | no |
| Ref 2 | 30 | 50 | 40 | no |
| Ex. 2 | 195* | 195* | 195* | yes |
| Ref 3 | 80 | 195* | 157 | no |
| Ex 3a | 195* | 195* | 195* | yes |
| Ex 3b (comp.) | 155 | 155 | 155 | yes |
| Ex 3c | 195* | 195* | 195* | yes |
| Ref 4 | 75 | 145 | 105 | no |
| Ex 4 (comp.) | 85 | 120 | 101 | yes |

### Fragment Retention

Examples 1a, 1 b, 2, 3a, 3c and 4 made it possible to show retention of glass-ceramic fragments during breakage. The examples of the references have never made it possible to retain the fragments when the substrate breaks. Example 1c (with non-fiber resin) does not allow the retention of the fragments

### Breakage Height

Examples 1a, 1b, 2 and 3a and 3c show a significant improvement in withstanding the impact of a dropped 500 g ball relative to their respective references. Example 4 (non-impregnated fabric, glued without heat treatment) does not show any significant improvement in impact strength.

The articles according to the invention can in particular be used advantageously to produce a new range of cooking plates for stoves or hobs or a new range of worktops, consoles, credenzas, central islands, etc.

1. A glass-ceramic article, comprising at least one substrate, said substrate being coated, on its lower face, in at least one zone, with a fibrous structure comprising fibers and a resin matrix.

2. The glass-ceramic article according to claim 1, wherein said fibrous structure comprises fibers chosen from glass fibers, carbon fibers, aramid fibers, quartz fibers, kevlar fibers, and mixtures thereof.

3. The glass-ceramic article according to claim 1, wherein said fibrous structure has a density of fibers between 50 and 1000 g/m².

4. The glass-ceramic article according to claim 1, wherein said resin is chosen from thermosetting resins.

5. The glass-ceramic article according to claim 1, wherein said resin is chosen from epoxy, phenolic or polyimide resins.

6. The glass-ceramic article according to claim 1, wherein the fibrous structure comprises one or more layers of a woven, unidirectional or multiaxial structure.

7. The glass-ceramic article according to claim 1, wherein said fibrous structure is deposited on at least 40% of the surface of the substrate.

8. The glass-ceramic article according to claim 1, wherein said fibrous structure has an expansion coefficient greater than a coefficient of expansion of the glass-ceramic plate.

9. The glass-ceramic article according to claim 1, wherein the substrate also comprises, on certain parts of its surface, an enamel coating.

10. The glass-ceramic article according to claim 9, wherein the enamel coating is arranged on the upper face of the substrate.

11. A method for manufacturing a glass-ceramic article, the method comprising applying on at least one substrate, made of glass-ceramic material, a fibrous structure comprising fibers and a resin matrix, then subjecting said substrate, thus coated, to a heat treatment under pressure in an autoclave or under vacuum.

12. The method according to claim 11, wherein the heat treatment is carried out at a temperature of between 10° and 200° C.

13. The method according to claim 11, wherein the heat treatment is carried out at a pressure of between 100 and 400 mbar.

14. The method according to claim 11, wherein the heat treatment is carried out for a duration of between 30 min and 3 hours.

15. The method according to claim 11, wherein the article is a cooking plate having heating zones and a control panel, wherein before applying the fibrous structure, the fibrous structure is precut to the size of the substrate and gaps are cut into the structure at the heating zones and optionally at the control panel.

16. The glass-ceramic article according to claim 1, wherein the at least one substrate is a glass-ceramic plate.

17. The glass-ceramic article according to claim 3, wherein said fibrous structure has a density of fibers between 100 and 800 g/m².

18. The glass-ceramic article according to claim 7, wherein said fibrous structure is deposited on at least 60% of the surface of the substrate.

19. The method according to claim 11, wherein the at least one substrate is a plate.

20. The method according to claim 12, wherein the heat treatment is carried out at a temperature of between 12° and 150° C.
